(19) United States
(12) Patent Application Publication
(10) Pub. No.: US 2011/0320180 A1
(43) Pub. Date: Dec. 29, 2011

(54) Migration Velocity Analysis of Seismic Data Using Common Image Cube and Green's Functions

(76) Inventor: Saleh M. Al-Saleh, Dhahran (SA)

(21) Appl. No.: 13/106,989

(22) Filed: May 13, 2011

Related U.S. Application Data
(60) Provisional application No. 61/359,583, filed on Jun. 29, 2010.

(51) Int. Cl. G01V 1/28; G06G 7/48; G01V 1/34

(52) U.S. Cl. 703/6; 702/18; 702/16

(57) ABSTRACT

Seismic data are assembled and stored for a set of cross-correlation lag times to form an array of common image gathers over depth levels of interest. The two dimensional gathers assembled over different lag times form a three-dimensional cube of common image data. The data are analyzed to determine the travel time shift required to equalize upgoing and downgoing wavefields. Events in the common image gathers are then modeled using Green's functions to generate a data set representing the data resulting from processing had a precise velocity model been obtainable from the seismic data. The generated data are then processed with inversion techniques to form a velocity model for seismic data analysis.

This application claims priority and benefit to U.S. Provisional Patent Application No. 61/359,583, by Al-Saleh, titled “Migration Velocity Analysis of Seismic Data Using Common Image Cube and Green's Functions” filed on Jun. 29, 2010, and which is incorporated herein by reference in its entirety.

### BACKGROUND OF THE INVENTION

1. Field of the Invention

The present invention relates to forming models of subsurface earth formations for seismic exploration and analysis.

2. Description of the Related Art

Seismic exploration involves the location of subsurface formations of interest for developing hydrocarbon production. Seismic data are obtained by imparting seismic energy to travel through the subsurface and recording the reflections of that energy which occur. The seismic data is then processed in computers so that the reflections or events, which occur at interfaces or boundaries between successive layers of formation rock, may be discerned and the data analyzed. One of the seismic data processing techniques is known as seismic migration.

Seismic migration analyzes the data to in effect transform it from an indication of the time at which a reflection occurred to a representation of where in the earth the reflection actually occurred. It is important that the migrated seismic data indicate as accurately as possible the actual position in the earth of the formation layers. In order to do so, an accurate model or representation is required of the velocity at which the seismic energy travels through the earth. Seismic velocity changes during the course of its travel, and is not a linear function. Obtaining a velocity model is done by a process known as migration velocity analysis.

Migration velocity analysis is commonly carried out in the common angle gathers domain in conjunction with ray-based tomography to build and update the velocity model. This approach can be challenging in the presence of large velocity errors, as it may require many migration velocity analysis computer processing iterations before converging to a model that can accurately represent the events.

Building subsurface velocity models from seismic data remains one of the challenges in geophysics. This is an ill-posed problem. In the presence of complicated subsurface structures which are present in many regions, building an accurate model requires many processing iterations and considerable effort. In some cases, the velocity modeling attempts may not converge to the true model. Data are typically contaminated with events that are not used in the velocity model scheme but rather mislead the process.

There have been other types of velocity modeling. A technique known as the residual curvature analysis approach analyzes the curvatures of reflection events on common image gathers of the seismic data. The migration velocity model would only be considered acceptable when the common image gathers contained flat events. In another technique, depth focusing analysis, known as the migration velocity model, was considered acceptable when the maximum energy build-up occurred at the zero-offset in a depth focusing panel. In what was known as common focus point analysis, the velocity model was considered acceptable when a differential time shift panel contained flat events. In these methods, the velocity model needed to be updated when these criteria are violated. Another method extended the cross correlation in space concept to cross correlation in time, introducing a time-shift imaging condition.

### SUMMARY OF THE INVENTION

Briefly, the present invention provides a new and improved method of forming a measure of the velocity of travel of seismic energy through subsurface formations from emission at a seismic energy source to reception at seismic energy receivers. Seismic data received at the receivers are assembled in the computer to form an array of common image data gathers as functions of cross-correlation lags and offset over depth levels of interest in the earth. An amount of seismic energy travel time required to equalize upgoing and downgoing wavefields for a selected seismic event from the assembled array of common image gathers is determined. The selected seismic event is one which indicates a cross-correlation lag providing a maximum seismic energy focus. The step of determining an amount of seismic energy travel time is repeated for other seismic events in the assembled array of common image gathers. From the determined amounts of travel time for the seismic events in the array of common image gathers a velocity function is determined. The determined velocity function indicates the seismic energy velocity for the depth levels of interest in the subsurface formations.

The present invention also provides a new and improved data processing system for forming a measure of the velocity of travel of seismic energy through subsurface formations from emission at a seismic energy source to reception at seismic energy receivers. The data processing system includes a data storage memory and a processor. The processor assembles in the storage memory of the data processing system seismic data received at the receivers to form an array of common image data gathers as functions of cross-correlation lags and offset over depth levels of interest in the earth. The processor also determines, from a selected seismic event of the assembled array of common image gathers which indicates a cross-correlation lag providing a maximum seismic energy focus, an amount of seismic energy travel time required to equalize upgoing and downgoing wavefields for the selected seismic event. The processor repeats the determination of an amount of seismic energy travel time for other seismic events in the assembled array of common image gathers. The processor also forms from the determined amounts of travel time for the seismic events in the array of common image gathers a velocity function indicating the seismic energy velocity for the depth levels of interest in the subsurface formations. The processor stores in the data storage memory the determined velocity functions for the seismic events indicating the seismic energy velocity for the depth levels of interest in the subsurface formations.

The present invention also provides a new and improved data storage device which has stored, in a computer readable medium, computer operable instructions for causing a data processing system to form a measure of the velocity of travel of seismic energy through subsurface formations from emission at a seismic energy source to reception at seismic energy receivers. The instructions stored in the data storage device cause the data processing system to assemble seismic data received at the receivers to form an array of common image data gathers as functions of cross-correlation lags and offset over depth levels of interest in the earth. The instructions also cause the data processing system to determine, from a selected seismic event of the assembled array of common image gathers which indicates a cross-correlation lag providing a maximum seismic energy focus, an amount of seismic energy travel time required to equalize upgoing and downgoing wavefields for the selected seismic event. The instructions cause the data processing system to repeat the step of determining an amount of seismic energy travel time for other seismic events in the assembled array of common image gathers, and form from the determined amounts of travel time for the seismic events in the array of common image gathers a velocity function indicating the seismic energy velocity for the depth levels of interest in the subsurface formations.

The present invention provides a two dimensional downward continuation based migration velocity analysis method that can be used in structurally complex areas. This approach requires fewer migration velocity analysis iterations than conventional migration velocity analysis schemes and does not assume small velocity perturbations. The present inventions can also be used for target oriented migration velocity analysis, which is extremely useful for subsalt imaging.

The present invention is based on relaxing the cross correlation imaging condition that is typically used in shot profile migration. Instead of using only the zero lag cross correlation at each depth level, other cross correlation lags are retained. The result, for a two dimensional data set, is a three dimensional common image cube of migrated data that contains more prestack information than other methods. Analyzing the data of the common image cube along a set of differing cross correlation lags, or in effect slicing the common image cube at different lags forms a series of common image gathers. In contrast, a conventional common image gather can be obtained at zero lag. When the background velocity model that is used for migration is different from the true velocity model, the best-flattened common image gather will not be at zero lag. Searching the common image cube at other lags for the most flattened common image gather gives the traveltime shift that is needed to approximately equalize the traveltimes of the upgoing (downward continued data) and downgoing (forward modeled source) wavefields.

For each event on the common image gather the cross correlation lag and depth at which it flattens best are selected. Then for each event, a Green's function or operator is modeled in a data processing system by seeding a source at the focusing depth using a one-way modeling algorithm, and determining a travel time using the Green's function operator. The travel time for this operator is then delayed by half of the focusing lag. This process is repeated for other events at different lateral positions. The result is a dataset whose traveltimes approximate the kinematics that would have generated if true velocity model was used to simulate these gathers.

### BRIEF DESCRIPTION OF THE DRAWINGS

FIG. 1 is a functional block diagram of a set of data processing steps performed in a computer or data processing system during migration velocity analysis according to the present invention.

FIG. 2 is a schematic diagram of a computer system for migration velocity analysis according to the present invention.

FIG. 3 is a prestack depth migrated image of seismic data obtained during processing according to the present invention.

FIGS. 4A and 4B are displays of common image cubes of seismic data obtained during processing according to the present invention.

FIGS. 5A and 5B are individual cross correlation lag slices of the common image cubes of seismic data of FIGS. 4A and 4B, respectively.

FIG. 6 is a display of wavefields as a function of offset and time from a portion of the data shown in FIG. 4B.

FIG. 7 is a data set of a test model used for processing according to the present invention.

FIG. 8A is a prestack depth migrated image of seismic data with a correct velocity model from processing according to the present invention.

FIG. 8B is a prestack depth migrated image of seismic data with an erroneous velocity model.

FIG. 9A is a zero lag common image gather of seismic data with a correct velocity model from processing according to the present invention.

FIG. 9B is a zero lag common image gather of seismic data with an erroneous velocity model.

FIG. 10 is an image of slices obtained from slices of a common image cube migrated with an erroneous velocity model.

FIG. 11 is a graphical representation of modeling using a Green's function.

FIGS. 12, 13 and 14 are plots of modeled Green's functions obtained with processing according to the present invention.

### DETAILED DESCRIPTION OF THE PREFERRED EMBODIMENTS

According to the present invention, a downward continuation based migration velocity analysis method is provided that can be used in structurally complex areas. This approach requires fewer migration velocity analysis iterations than conventional migration velocity analysis schemes and does not assume small velocity perturbations. The method of the present invention can also be used for target oriented migration velocity analysis, which is extremely useful for subsalt imaging. The technique is based on relaxing the cross correlation imaging condition that is typically used in shot profile migration. Instead of using only the zero lag cross correlation at each depth level, we retain other cross correlation lags are retained. The result, for a two dimensional dataset, is a three dimensional common image cube of migrated data that contains more prestack information than previous methods. Analyzing the data of the common image cube along a set of differing cross correlation lags, or in effect slicing this cube at different lags forms a series of common image gathers, whereas the conventional common image gather can be obtained by slicing the cube at the zero lag. When the background velocity model that is used for migration is different from the true velocity model, the best-flattened common image gather will not be at zero lag. Searching the cube at other lags for the most flattened common image gather gives the traveltime shift that is needed to approximately equalize the traveltimes of the upgoing (downward continued data) and downgoing (forward modeled source) wavefields.

For each event on the common image gather, the cross correlation lag and depth at which it flattens best are selected. Then for each event, a Green's function is modeled by seeding a source at the focusing depth using one-way modeling. The traveltime is then delayed for this operator by half of the focusing lag. This process is then repeated for other events at different lateral positions. The result is a dataset whose traveltimes approximate the kinematics that would have been generated if a true velocity model was used to simulate these gathers.

These data driven, modeled Green's functions can be stacked to form a focused time image. They can also be picked with RMS velocities and then converted to interval velocities using a constrained Dix inversion technique. In areas with complex subsurface structures, more sophisticated methods could be used such as global traveltime tomography and waveform inversion. As will be set forth, a synthetic dataset is processed according to the present invention, and the obtained results show that the present invention is a promising analytical tool for migration velocity analysis in complex areas.

A two dimensional common image gather at a specific lateral position, x₀, can be constructed using:

$$CIG ( {x}_{s} , {x}_{0} , z ; {V}_{m} ) = {\sum }_{ω} {U}^{-} ( {x}_{s} , {x}_{0} , z , ω ; Vm ) D + ( {x}_{s} , {x}_{0} , z , ω ; {V}_{m} ) * exp ( i ω ( τ = 0 ) ) , \qquad ( 1 )$$

where xₛ is the surface source location, z is the depth coordinate, τ is the cross correlation lag, ω is the angular frequency, and Vₘ is the background velocity model used for migration. The final image can be obtained by stacking Equation (1) over xₛ. Equation (1) shows that common image gathers can be formed by cross correlating the upgoing and downgoing wavefields and only retaining the zero lag information at each depth level—they are obtained after invoking the imaging condition. In this context, the upgoing wavefield is the downward continued recorded data, and the downgoing wavefield is the forward modeled, or simulated, source wavefield.

The present invention is based on an approach called common image cube analysis. Instead of simply taking the zero lag cross correlation, or stacking over the shot index, other cross-correlation lags are stored without stacking. This is done for all depth levels of interest. A common image cube (CIC) is generated using the following equation:

$$CIC ( {x}_{s} , {x}_{0} , z , τ , {V}_{m} ) = {\sum }_{ω} {U}^{-} ( {x}_{s} , {x}_{0} , z , ω ; Vm ) D + ( {x}_{s} , {x}_{0} , z , ω ; {V}_{m} ) * exp ( i ω τ ) , \qquad ( 2 )$$

For two dimensional survey data, the result is a cube of data that contains more prestack information than other methods. The resultant cube is a three dimensional common image cube of migrated data that contains more prestack information than previous methods. Analyzing the data of the common image cube along a set of differing cross correlation lags, or in effect slicing this cube at different time lags forms a series of common image gathers where the zero lag gather is the conventional common image gather. Tests on synthetic models according to the present invention show that this technique is a promising tool for migration velocity analysis. This migration velocity analysis common image cube (CIC) can also be constructed from common angle gathers. In Equation (2), the common image cube shows the time correlation between the wavefields at each depth level.

### Analyzing the Common Image Cube

The prestack depth migration of a two dimensional dataset of S shots using a background velocity model, Vₘ, with the imaging condition of Equation (2) results in a set of depth focusing gathers, CIC(xₛ,xₒ,z,t;Vₘ). Let a reflection event in a specific depth-focusing gather, obtained at some specific τ at lateral position xₒ, be identified with the surface zₑ(xₛ,t). Typically, this event will correspond to a set of local cross correlation maxima over τ and xₛ, while the other variables are held constant, in the sense that

|CIC(xₛ,x₀,zₑ(xₛ,t),t;Vₘ|=max_{loc}(|CIC(xₛ,x₀z,t;Vₘ|), (3)

Such that zₑ(xₛ,t) has spatial continuity over (xₛ,t), where ∥ denotes the Lₗ norm. At this time, the identification of reflection event surfaces is fundamentally subjective and interpretive. Defining φₑ such that

φₑ(xₛ,t)=|zₑ(xₛ,t)− z̅ₑ(t)| (4)

Where z̅ₑ(t) is the average over xₛ for a fixed t

z̅ₑ(t)=mean(zₑ(xₛ,t)). (5)

The lag at which this summation,

$${\sum }_{{x}_{s}} {φ}_{e} ( {x}_{s} , τ ) , \qquad ( 6 )$$

is a minimum is called the focusing lag, τ_{f}. Therefore there exists a focusing depth, z_{f}, such that

z_{f}= z̅ₑ(t_{f}). (7)

Thus z_{f} is the average depth of that part of zₑ(xₛ,t) which is sufficiently flat. At a position (x₀,z_{f}), Vₘ is correct to e periods

|t_{f}|fₘₐₓ<e, (8)

for the smallest nonnegative, dimensionless number e>0, and if

0<ε<σ (9)

then Vₘ≅V, z_{f}≅zᵣ, and τ_{f}≅0, where zᵣ is the true reflector depth and σ is a user defined parameter that determines the maximum deviation from flatness.

An event on a common image gather can be either flat, frown, or smile depending on the velocity model used for the migration. The terms frown and smile are used in the art to refer to the similarity of the data plots to corresponding facial expressions. In common image cube analysis, the same event appears as a surface extending laterally through the cube instead of just a two dimensional event. Slicing this surface shows the focusing of the event at different lags, which correspond to different depths. If the flattest part of this surface occurs close to the zero lag then the velocity model is acceptable. If the flattest part of that surface occurs at a non-zero lag, then the velocity field needs to be updated. The lag and depth at which the flattest part occurs are called the focusing lag, τ_{f} and the focusing depth, z_{f}, respectively.

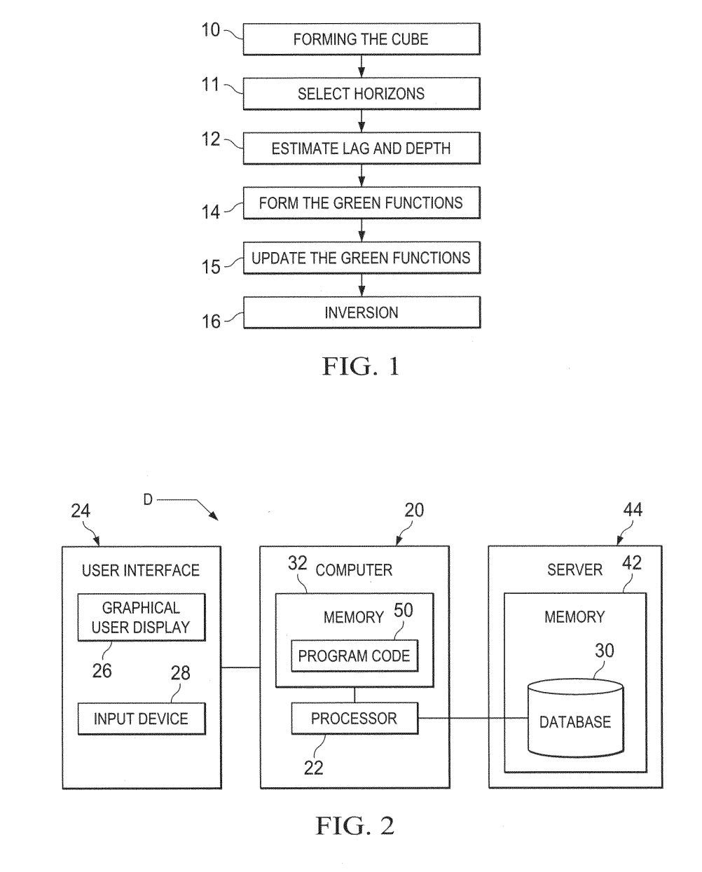

FIG. 1 illustrates schematically a preferred sequence of a computer implemented method of forming a measure of the velocity of travel of seismic energy through subsurface formations from emission at a seismic energy source to reception at seismic energy receivers. The seismic data is obtained in the customary manner by recording the responses of subsurface formations as a function of time after the seismic energy is emitted. As shown at step 10, a common image cube of the seismic data is assembled in the data processing system D (FIG. 2) according to Equation (2) set forth above.

During step 11, horizons or seismic events of interest in the assembled common image cube are individually selected. Measures of the cross-correlation lag and depth for the selected event are then forwarded during step 12 and the lag and depth which indicate maximum energy forces are identified, as will be set forth.

During step 14, Green's functions or operator algorithms are approximated in the data processing system D by one-way wave equation modeling for each position pair (x₀,z_{f}), as will be set forth. In step 15, the Green's function is then updated by half the lag value applied to the traveltime. Velocity functions are then formed in step 16 using a suitable inversion technique. The inversion methodology used can vary in complexity based on the complexity of the subsurface structure. For simpler structure, inversion methods producing RMS velocities may be used, for example. It should be understood that more advanced presently available inversion methods described below, such as traveltime tomography and waveform inversion, may also be used.

As illustrated in FIG. 2, the data processing system D includes a computer 20 having a processor 22 and memory 24 coupled to the processor 22 to store operating instructions, control information and database records therein. The computer 20 may, if desired, be a multicore processor with nodes such as those from Intel Corporation or Advanced Micro Devices (AMD). The computer 20 may also be a mainframe computer of any conventional type of suitable processing capacity such as those available from International Business Machines (IBM) of Armonk, N.Y. or other source. As noted below, other digital processors may also be used, as well.

It should be noted that other digital processors, may be used, such as personal computers in the form of a laptop computer, notebook computer or other suitable programmed or programmable digital data processing apparatus.

The processor 22 is typically in the form of a computer having a user interface 24 and an output display 26 for displaying output data or records of processing of seismic data measurements performed according to the present invention. The output display 26 includes components such as a printer and an output display screen capable of providing printed output information or visible displays in the form of graphs, data sheets, graphical images, data plots and the like as output records or images.

The user interface 24 of computer 20 also includes a suitable user input device or input/output control unit 28 to provide a user access to control or access information and database records and operate the computer 20. Data processing system D further includes a database 30 stored in memory, which may be internal memory 32, or an external, networked, or non-networked memory as indicated at 42 in an associated database server 44.

The data processing system D includes program code 50 stored in memory 32 of the computer 20. The program code 50, according to the present invention is in the form of computer operable instructions causing the data processor 22 to form velocity models of the travel of seismic energy through subsurface formations, as will be set forth.

It should be noted that program code 50 may be in the form of microcode, programs, routines, or symbolic computer operable languages that provide a specific set of ordered operations that control the functioning of the data processing system D and direct its operation. The instructions of program code 50 may be may be stored in memory 32 of the computer 20, or on computer diskette, magnetic tape, conventional hard disk drive, electronic read-only memory, optical storage device, or other appropriate data storage device having a computer usable medium stored thereon. Program code 50 may also be contained on a data storage device such as server 44 as a computer readable medium, as shown.

As set forth above, the process of the present invention forms the common image cube from two dimensional data at each analysis lateral position. Events are then identified on common image cubes and the focusing depth and lag are determined at each position. Then, a one-way wave equation modeling program is used to approximate a Green's function for each pair of (x₀,z_{f}) where the source is seeded at the focusing depth. The focusing lag is then used to update the Green's function with half the lag value applied to the traveltime of the modeled event as will now be described.

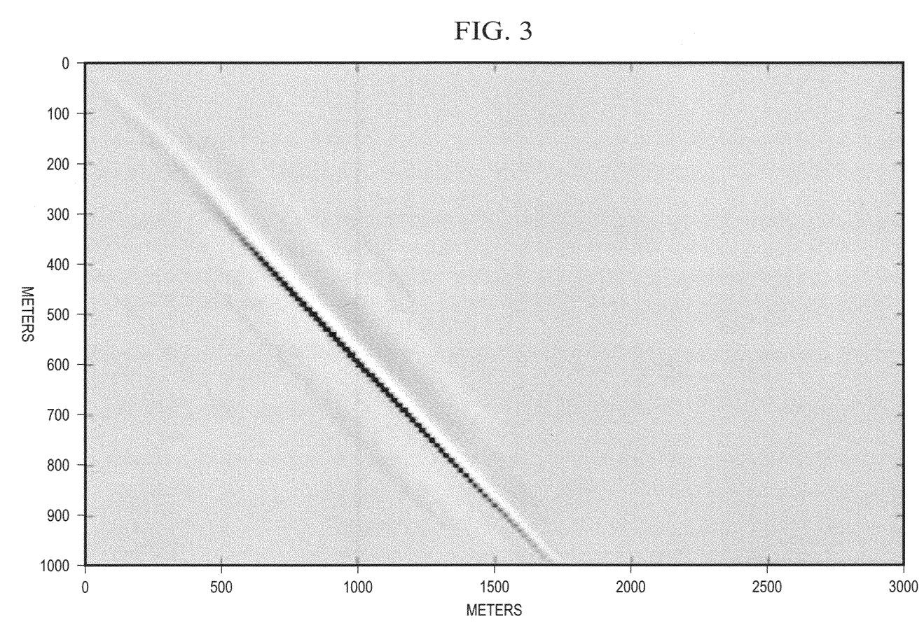

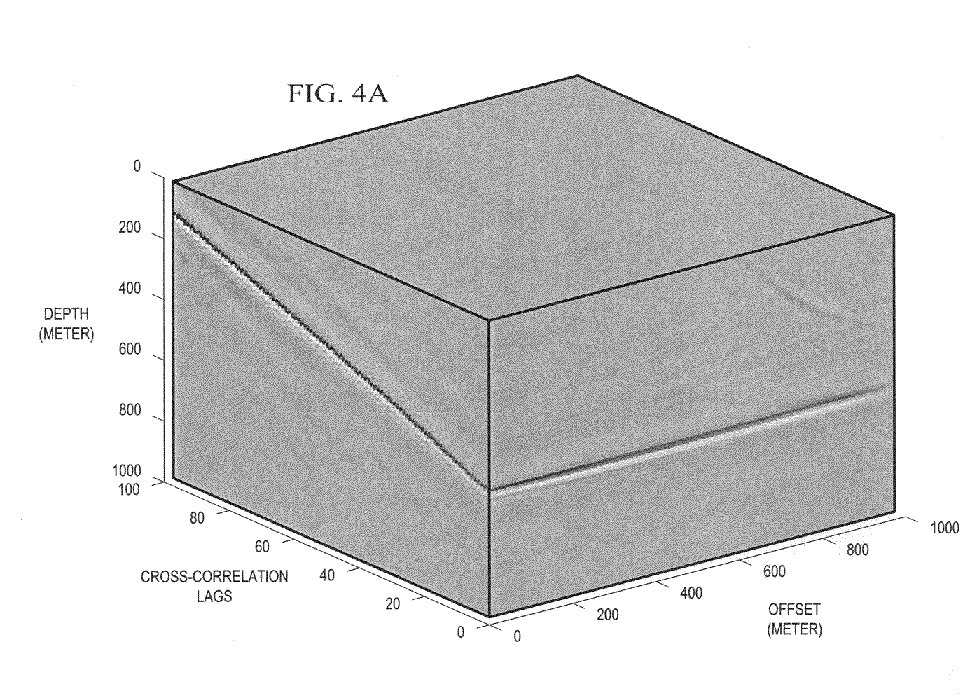

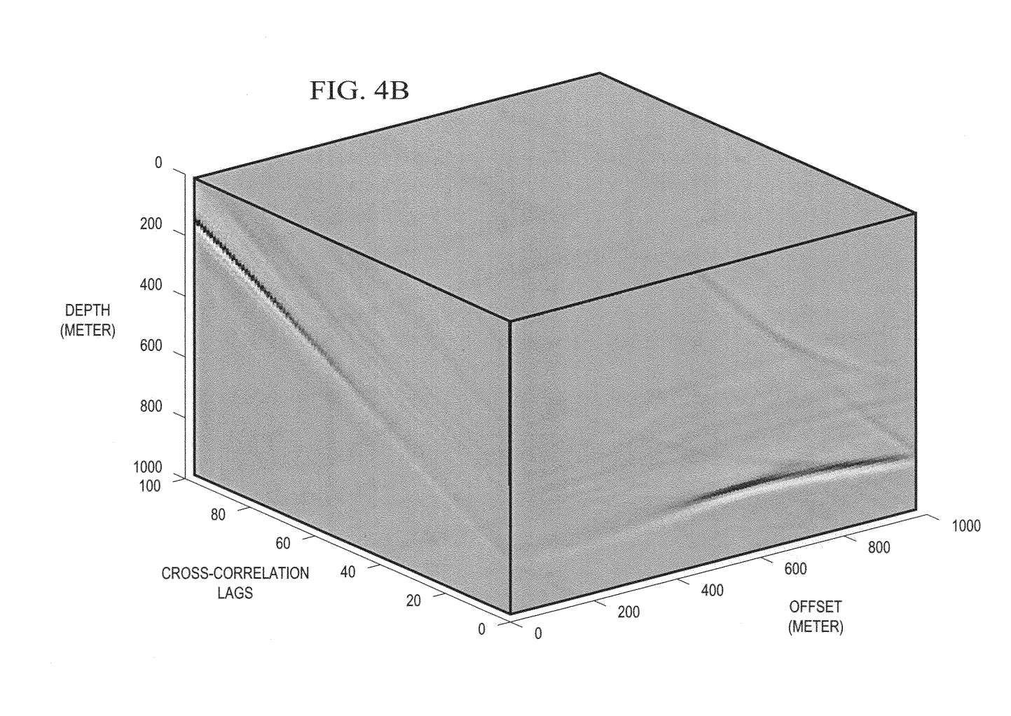

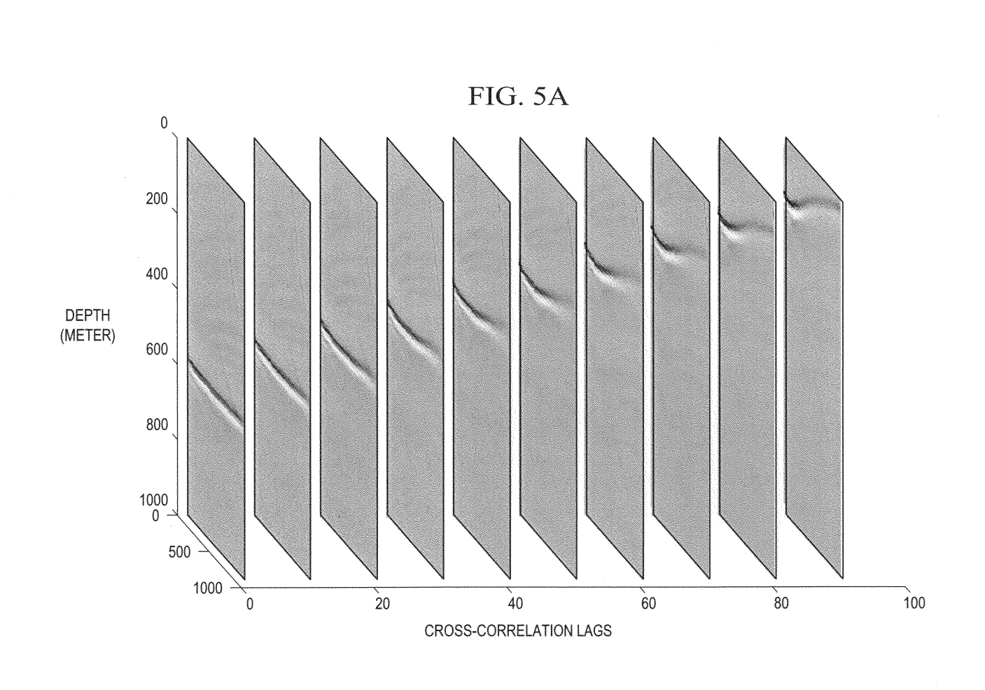

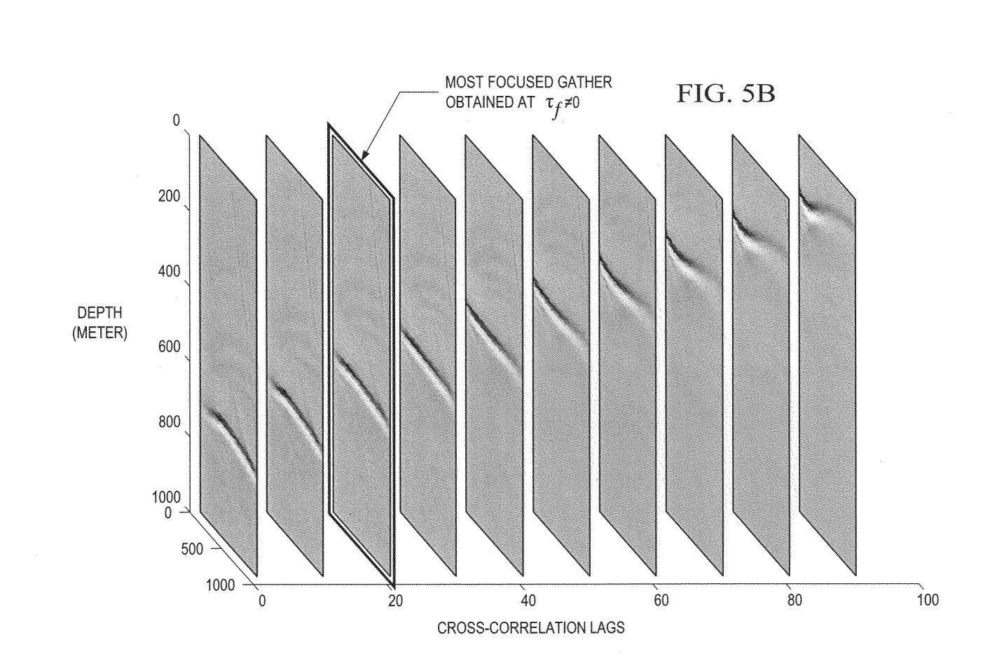

A prestack depth migrated image of 100 shots, simulated over a dipping reflector in a constant velocity medium, is shown in FIG. 3. A known correct velocity, V=2000 m/s or Vₘ=V, was used in the migration. FIGS. 4A and 4B show the common image cubes at one lateral position (see the dashed line in FIG. 3) for two different velocities: and Vm≅V and Vm>V, respectively. Slicing the cube shown in FIG. 4A shows that for the Vm≅V case (FIG. 5A), the zero lag gather, CIC(xₛ,xₒ,z,t=0; Vₘ), is the most focused gather. That is, the reflection event appears to be flat. On the other hand, for the second case (FIG. 5B), where Vₘ>V, the zero lag gather is not the most focused and the reflection event appears to be what is known in the art as a frown. The gather where the event is best focused, CIC(xₛ,xₒ,z,t=t_{f};Vₘ), can be obtained by slicing the cube at vertical positions corresponding to a value of 30 different correlation lags.

Each trace of the prestack depth migration images in FIG. 3 is the stack, over xₛ, of the gather obtained at the zero lag, that is,

$${\sum }_{{x}_{s}} CIC ( {x}_{s} , {x}_{o} , z , t = 0 ; {V}_{m} ) .$$

Conventionally, heretofore, only the zero lag slice of the cube has been typically obtained and used to form the final image. However, with the present invention, the cube of data from FIG. 3 contains a considerable prestack information that can be used for migration velocity analysis.

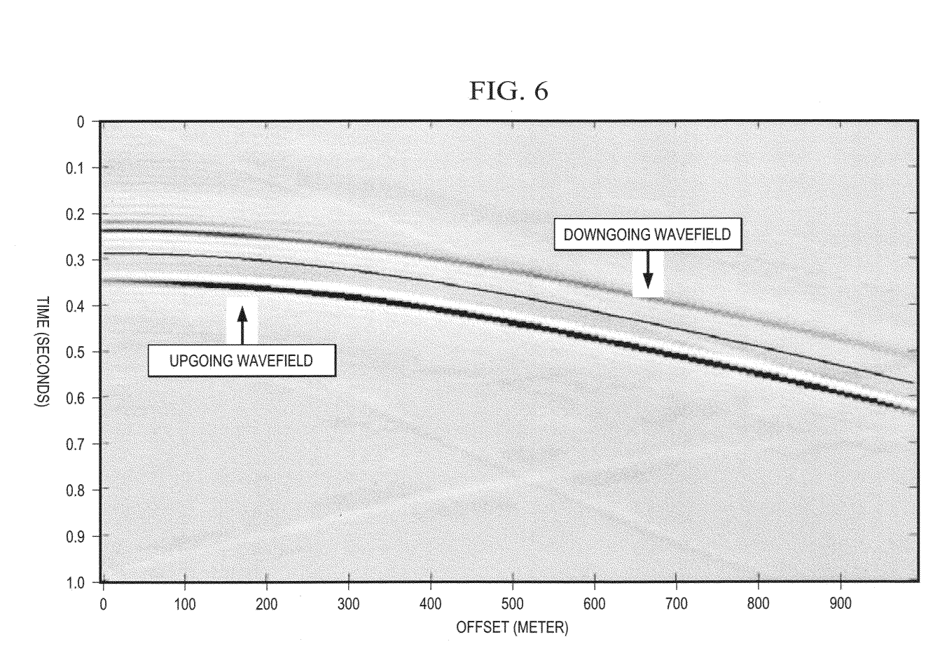

FIG. 6 shows composites of the upgoing and modeled (from the Green's function) wavefields for the same lateral position, indicated by the dotted line in FIG. 3 where the velocity Vₘ>V. The Green's function was modeled by seeding the source at the focusing lag (x₀,z_{f}) picked from FIG. 5B. Two reflection events can be identified that have traveltime functions: tᵤ(xₛ) that corresponds to the traveltime of the event in the upgoing wavefield, and t_{d}(xₛ) that corresponds to the reflection event in the modeled wavefield. The exact traveltime calculated using the correct velocity is shown in blue for comparison. The true traveltime, in a constant velocity medium, was calculated using

$$t ( {x}_{s} ) = \sqrt{{( \frac{2 {z}_{r}}{V} )}^{2} + {( \frac{{x}_{s}}{V} )}^{2}} . \qquad ( 10 )$$

Promising observations can be drawn from this example: the traveltime differences between the upgoing and modeled wavefields have a very weak offset dependency, even with a relatively large velocity error for a dipping reflector. The traveltime difference can be approximated using τ_{f}. It can also be observed that t_{d}(xₛ)+τ_{f}/2 is a good approximation of the true traveltime. This means that when the subsurface is not overly complex, Dix conversion can be used to generate accurate results even with large velocity errors. However, for complex subsurface environments, tomography or waveform inversion should be used.

### Synthetic Data Example

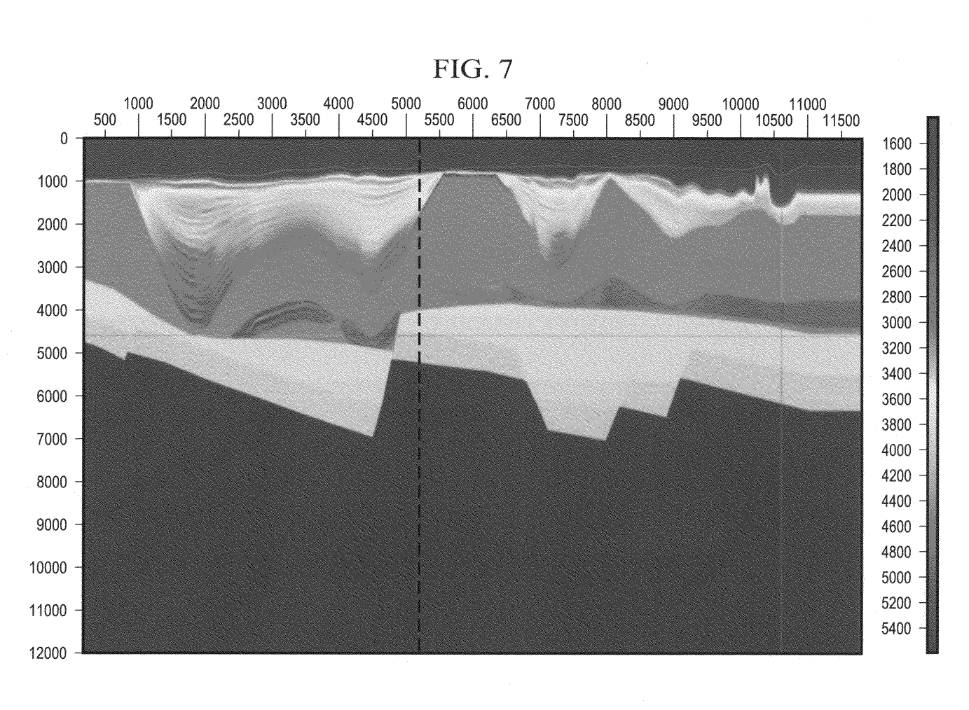

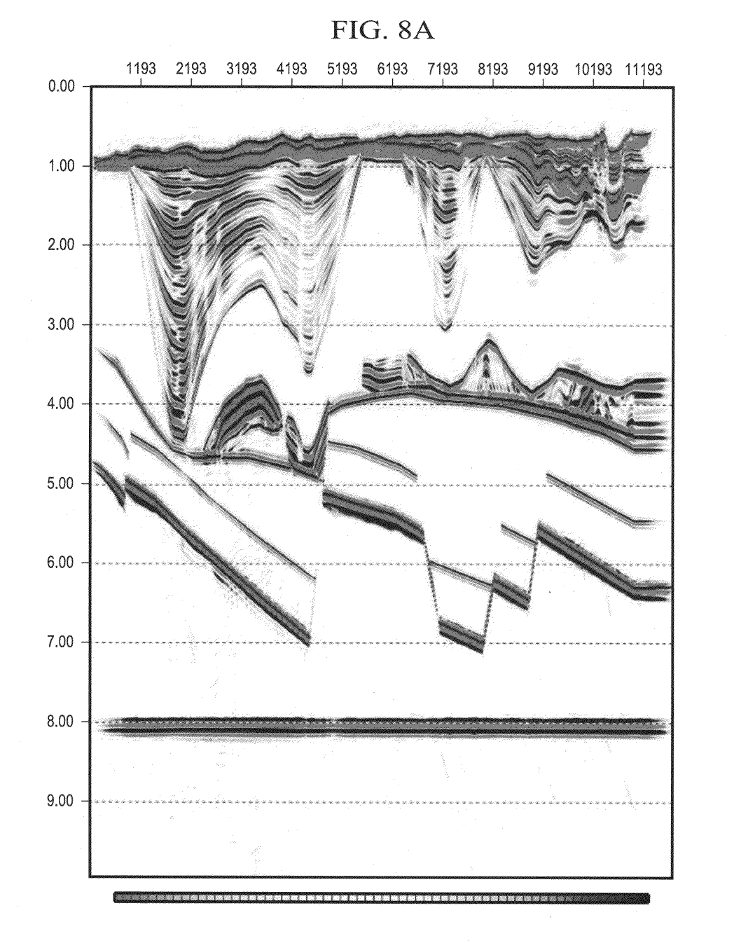

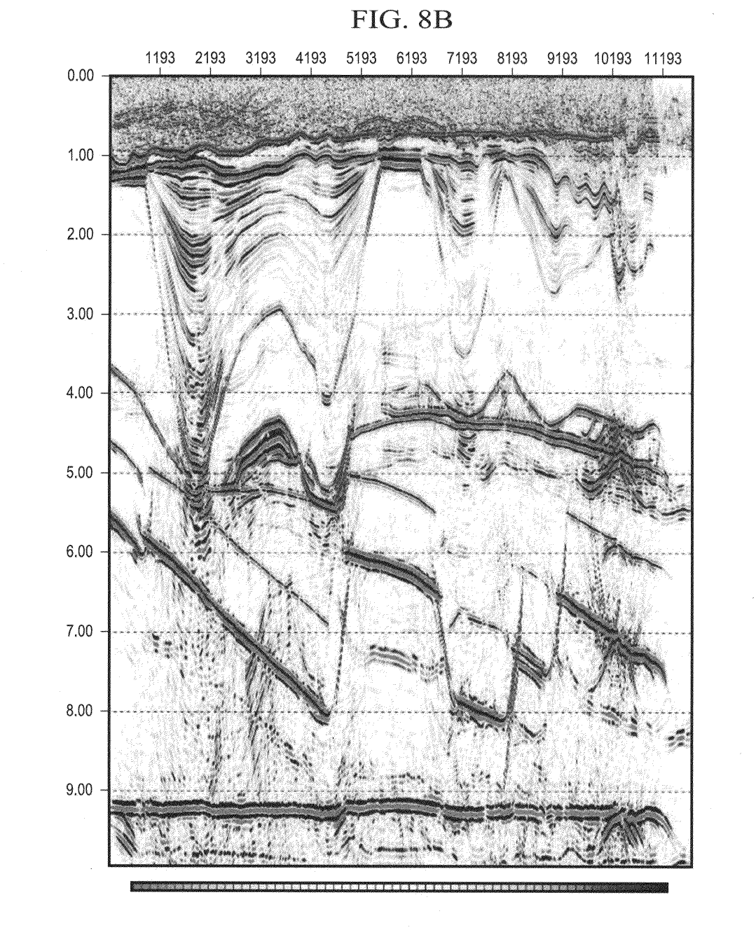

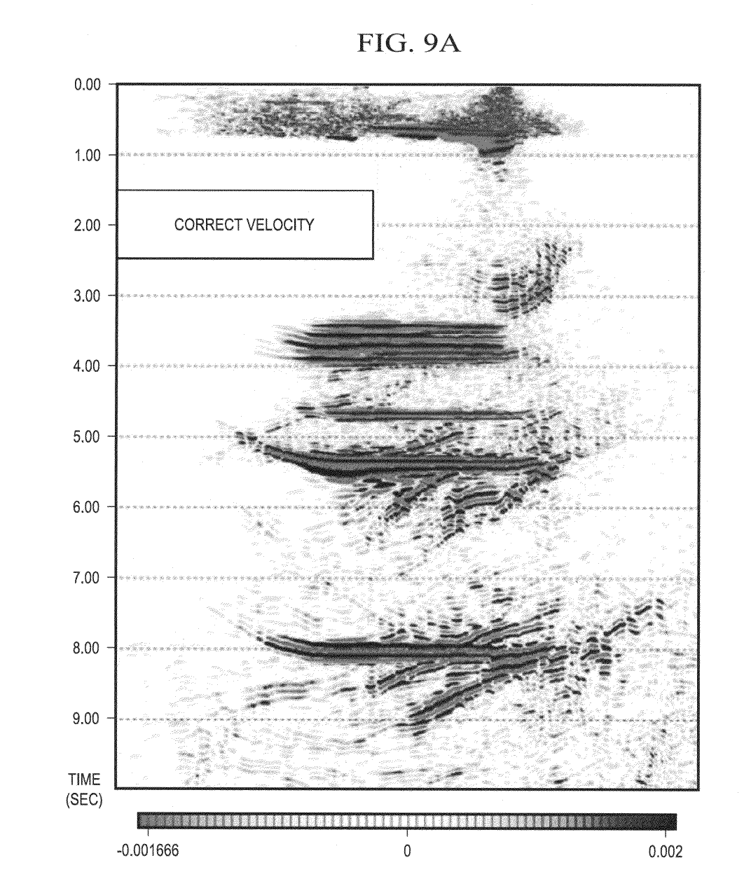

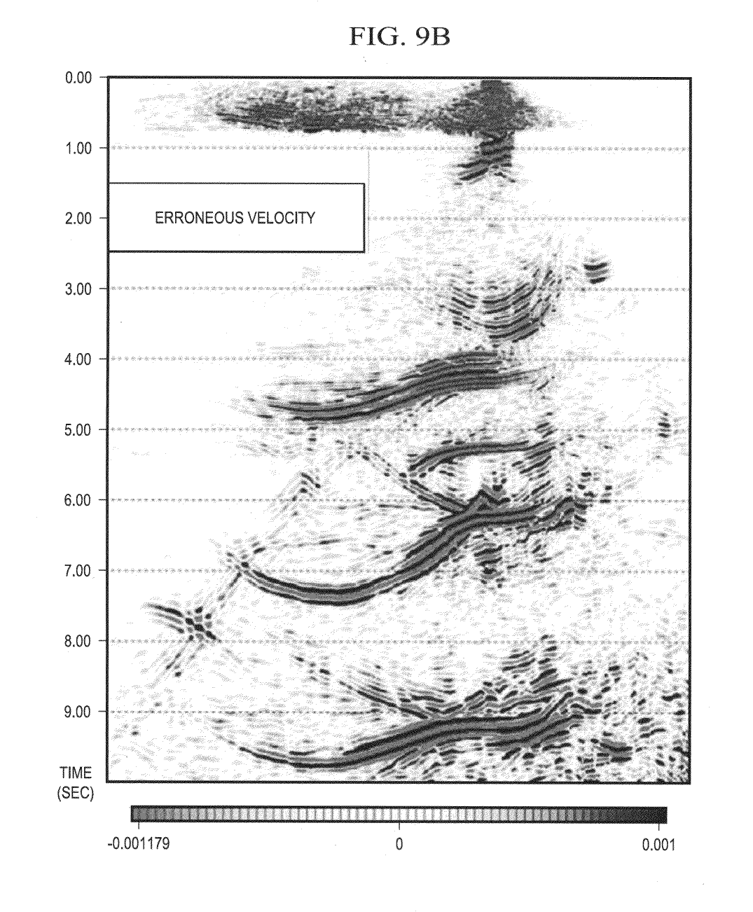

The technology of the present invention was applied to a synthetic dataset representing complex subsurface features. The dataset is composed of 5596 shots with 812 channels per shot. The receiver and shot spacing are 12.5 and 25 meters, respectively, FIG. 7 shows a velocity model that was used in an acoustic finite modeling program to create the synthetic data. FIGS. 8A and 8B show the prestack depth migration images obtained with an accurate or correct seismic velocity model and one with the velocity increased by 10%. Both datasets were migrated using a phase-shift plus interpolation algorithm with 15 reference velocities. FIGS. 9A and 9B show zero lag common image gathers generated with the correct and incorrect (10% higher) velocity fields.

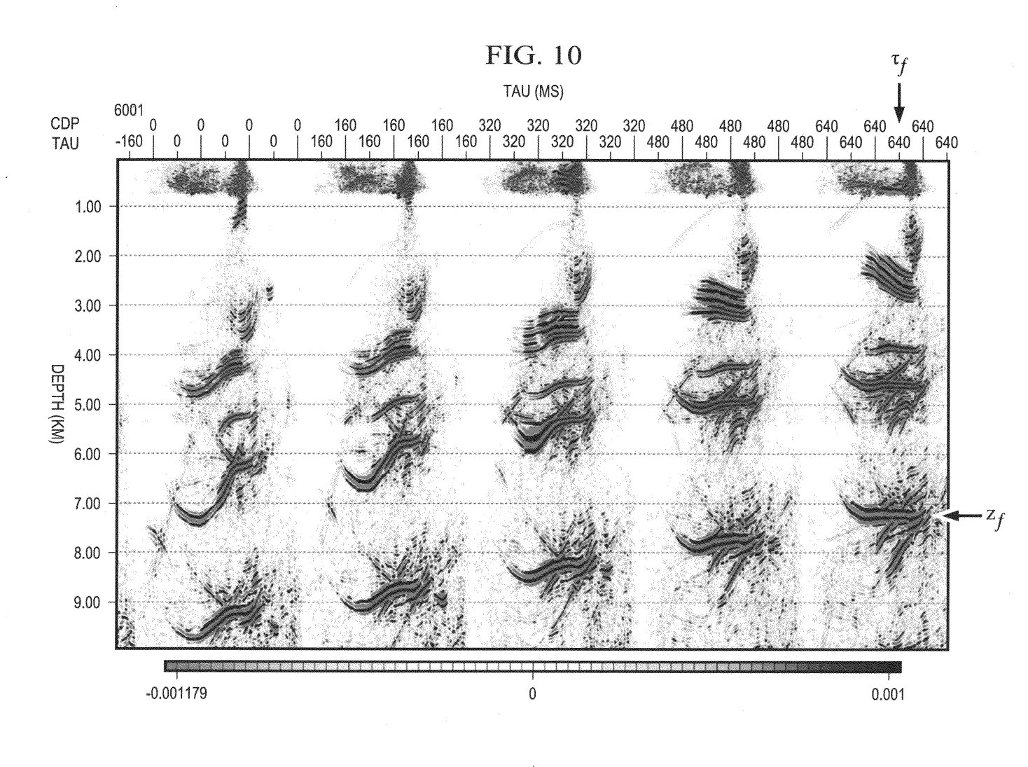

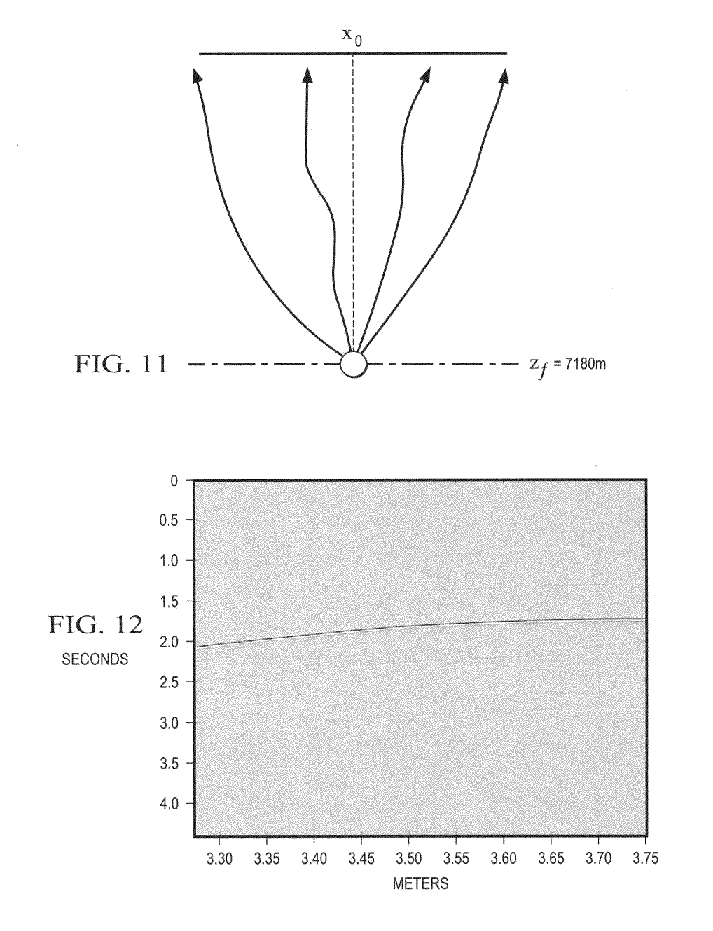

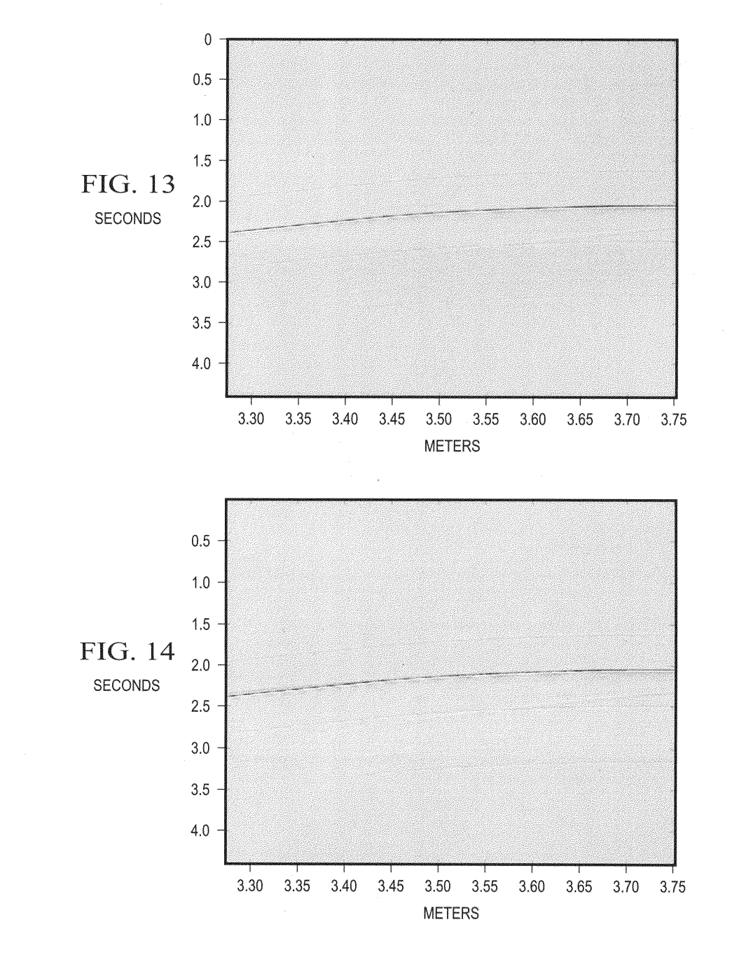

Migrating the dataset with the 10% higher velocity model and slicing the common image cube, generated at the lateral position indicated by the dashed line in FIG. 7, gives common image gathers at different lags (FIG. 10). The zero lag common image gather highlighted by the black rectangle does not contain flat events, since an incorrect velocity was used. The different events, however, can be seen to flatten at different lags. For example, the deepest event, below 9000 m, on the zero lag common image gather (indicated by an arrow) is not flat, but the same event can be seen to flatten at the common image gather obtained at lag τ=640 ms and at a depth of z_{f}=7180 m. The Green's function modeled by seeding a delta function at (x₀,z_{f}) is shown in FIG. 11.

FIG. 12 shows the Green's function from the 7180 m focusing depth modeled using a phase shift plus interpolation algorithm with 15 reference velocities. FIG. 13 shows the Green's function after updating with τ/2 or 320 ms. Fitting a hyperbola with the correct root mean square (RMS) velocity closely approximates the modeled Green's function where a good approximation of the true velocity can be obtained.

The common image cube (CIC) allows more prestack data to be used in the velocity analysis process than conventional migration velocity analysis methods. The present invention can be implemented in a production type environment. The present requires more gathers for each lateral position than conventional migration velocity analysis. To make the process more efficient, the gathers can be provided as outputs at a coarse cross correlation lag interval to reduce the data handling requirements. This approach can output Green's functions with kinematics that approximate operators obtained using a known correct velocity. Picking RMS velocities from the updated gathers with the present invention has proven to be a convenient inversion scheme, but is likely not optimal in a complex velocity environment. Advanced inversion schemes such as global traveltime tomography and waveform inversion may be considered in more complex areas. The present invention is a promising tool for building velocity models for subsalt imaging.

The present invention can be used in a complex environment to build subsurface velocity models. Unlike existing methods, the present invention need not overcome problems encountered with actual data such as noise, multiples, converted waves, and the like. The present invention prepares data with the kinematics that approximate the data had true velocity model been known and used. Thereafter, different inversion schemes can be used to construct the velocity model.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of forming a measure of the velocity of travel of seismic energy through subsurface formations from emission at a seismic energy source to reception at seismic energy receivers, comprising the steps of:
assembling in a computer seismic data received at the receivers to form an array of common image data gathers as functions of cross-correlation lags and offset over depth levels of interest in the earth;
determining in the computer, from a selected seismic event of the assembled array of common image gathers which indicates a cross-correlation lag providing a maximum seismic energy focus, an amount of seismic energy travel time required to equalize upgoing and downgoing wavefields for the selected seismic event;
repeating the step of determining an amount of seismic energy travel time for other seismic events in the assembled array of common image gathers; and
forming in the computer from the determined amounts of travel time for the seismic events in the array of common image gathers a velocity function indicating the seismic energy velocity for the depth levels of interest in the subsurface formations.

2. The computer implemented method of claim 1, further including the step of:
partitioning the assembled array of common image gathers into individual common image gathers exhibiting a different lag from other common image gathers in the assembled array.

3. The computer implemented method of claim 2, further including the step of:
displaying one of the individual common image gathers for analysis of a seismic event in the displayed common image gather.

4. The computer implemented method of claim 3, wherein a seismic event in the displayed common image gather which indicates a cross correlation lag providing a maximum energy focus is selected.

5. The computer implemented method of claim 1, further including the step of:
determining a travel time shift to equalize travel times of upgoing and downgoing wavefields of the seismic energy.

6. The computer implemented method of claim 1, further including the step of:
applying a Green's function operator to the seismic data at the depth of an event in the common image gather.

7. The computer implemented method of claim 1, further including the step of:
applying a Green's function operator to the seismic data at the depth of a selected event which indicates a cross correlation lag providing a maximum energy focus in the common image gather.

8. The computer implemented method of claim 7, further including the step of:
repeating the step of applying a Green's function operator to the seismic data at the depth of other events in the common image gather at different lateral positions in the common image gather than the event indicates a cross correlation lag providing a maximum energy focus.

9. The computer implemented method of claim 7, further including the step of:
forming a data set of the events in the common image gather with travel times simulating a true velocity model of the subsurface formations.

10. A data processing system for forming a measure of the velocity of travel of seismic energy through subsurface formations from emission at a seismic energy source to reception at seismic energy receivers, the data processing system comprising:
a data storage memory;
a processor for performing the steps of:
assembling in the storage memory of the data processing system seismic data received at the receivers to fox iii an array of common image data gathers as functions of cross-correlation lags and offset over depth levels of interest in the earth;
determining, from a selected seismic event of the assembled array of common image gathers which indicates a cross-correlation lag providing a maximum seismic energy focus, an amount of seismic energy travel time required to equalize upgoing and downgoing wavefields for the selected seismic event;
repeating the step of determining an amount of seismic energy travel time for other seismic events in the assembled array of common image gathers; and
forming from the determined amounts of travel time for the seismic events in the array of common image gathers a velocity function indicating the seismic energy velocity for the depth levels of interest in the subsurface formations; and
storing in the data storage memory the determined velocity functions for the seismic events indicating the seismic energy velocity for the depth levels of interest in the subsurface formations.

11. The data processing system of claim 10, wherein the processor further performs the step of:
partitioning the assembled array of common image gathers into individual common image gathers exhibiting a different lag from other common image gathers in the assembled array.

12. The data processing system of claim 11, wherein the data processing system further includes a display which performs the step of:
displaying one of the individual common image gathers for analysis of a seismic event in the displayed common image gather.

13. The data processing system of claim 12, wherein a seismic event in the displayed common image gather which indicates a cross correlation lag providing a maximum energy focus is selected.

14. The data processing system of claim 10, wherein the processor further performs the step of:
determining a travel time shift to equalize travel times of upgoing and downgoing wavefields of the seismic energy.

15. The data processing system of claim 10, wherein the processor further performs the step of:
applying a Green's function operator to the seismic data at the depth of an event in the common image gather.

16. The data processing system of claim 10, wherein the processor further performs the step of:
applying a Green's function operator to the seismic data at the depth of a selected event which indicates a cross correlation lag providing a maximum energy focus in the common image gather.

17. The data processing system of claim 16, wherein the processor further performs the step of:
repeating the step of applying a Green's function operator to the seismic data at the depth of other events in the common image gather at different lateral positions in the common image gather than the event indicates a cross correlation lag providing a maximum energy focus.

18. The data processing system of claim 16, wherein the processor further performs the step of:
forming a data set of the events in the common image gather with travel times simulating a true velocity model of the subsurface formations.

19. A data storage device having stored in a computer readable medium computer operable instructions for causing a data processing system to form a measure of the velocity of travel of seismic energy through subsurface formations from emission at a seismic energy source to reception at seismic energy receivers, the instructions stored in the data storage device causing the data processing system to perform the following steps:
assembling in the data processing system seismic data received at the receivers to form an array of common image data gathers as functions of cross-correlation lags and offset over depth levels of interest in the earth;
determining in the data processing system, from a selected seismic event of the assembled array of common image gathers which indicates a cross-correlation lag providing a maximum seismic energy focus, an amount of seismic energy travel time required to equalize upgoing and downgoing wavefields for the selected seismic event;
repeating the step of determining an amount of seismic energy travel time for other seismic events in the assembled array of common image gathers; and
forming in the data processing system, from the determined amounts of travel time for the seismic events in the array of common image gathers, a velocity function indicating the seismic energy velocity for the depth levels of interest in the subsurface formations.

20. The data storage device of claim 19, wherein the instructions further include instructions causing the data processing system to perform the step of:
partitioning the assembled array of common image gathers into individual common image gathers exhibiting a different lag from other common image gathers in the assembled array.

21. The data storage device of claim 19, wherein the instructions further include instructions causing the data processing system to perform the step of:
displaying one of the individual common image gathers for analysis of a seismic event in the displayed common image gather.

22. The data storage device of claim 21, wherein a seismic event in the displayed common image gather which indicates a cross correlation lag providing a maximum energy focus is selected.

23. The data storage device of claim 19, wherein the instructions further include instructions causing the data processing system to perform the step of:
determining a travel time shift to equalize travel times of upgoing and downgoing wavefields of the seismic energy.

24. The data storage device of claim 19, wherein the instructions further include instructions causing the data processing system to perform the step of:
applying a Green's function operator to the seismic data at the depth of an event in the common image gather.

25. The data storage device of claim 19, wherein the instructions further include instructions causing the data processing system to perform the step of:
applying a Green's function operator to the seismic data at the depth of a selected event which indicates a cross correlation lag providing a maximum energy focus in the common image gather.

26. The data storage device of claim 25, wherein the instructions further include instructions causing the data processing system to perform the step of:
repeating the step of applying a Green's function operator to the seismic data at the depth of other events in the common image gather at different lateral positions in the common image gather than the event indicates a cross correlation lag providing a maximum energy focus.

27. The data storage device of claim 25, wherein the instructions further include instructions causing the data processing system to perform the step of:
forming a data set of the events in the common image gather with travel times simulating a true velocity model of the subsurface formations.
